(19) United States
(12) Patent Application Publication
(10) Pub. No.: US 2015/0277407 A1
(43) Pub. Date: Oct. 1, 2015

(54) LOCATION DETECTION OF CONTROL EQUIPMENT IN A BUILDING

(71) Applicant: TRANE INTERNATIONAL INC., Piscataway, NJ (US)

(72) Inventors: Christopher Conrad Vanderkoy, Saint Paul, MN (US); John Conrad Olson, Shoreview, MN (US); Alejandro Jimenez, Maple Grove, MN (US)

(21) Appl. No.: 14/669,927

(22) Filed: Mar. 26, 2015

Related U.S. Application Data
(60) Provisional application No. 61/971,271, filed on Mar. 27, 2014.

(51) Int. Cl. G05B 15/02; H04L 12/28

(52) U.S. Cl. CPC G05B 15/02; H04L 12/2803

(57) ABSTRACT

A system and method for determining a location of an equipment controller within a building including a building automation system are disclosed. The method includes receiving, by a main controller of the building automation system, a request from a mobile device to locate an equipment controller. The main controller monitors one or more sensors that are in communication with the main controller for a user-initiated communication-modifying event in response to receiving the request from the mobile device. The main controller determines a hardware address of the equipment controller in response to receiving a user-initiated communication-modifying event from one of the equipment controller and of the one or more sensors.

### FIELD

Embodiments of this disclosure relate generally to a building automation system. More specifically, the embodiments relate to a system and method for locating an equipment controller within a building including a building automation system.

### BACKGROUND

A building automation system is a computerized network of electronic devices that can be configured to control one or more systems (e.g., mechanical, electrical, lighting, security, or the like) in a building. For example, a building automation system can be configured to control a heating, ventilation, and air conditioning (HVAC) system and its components for a building. A user (e.g., a facility manager, a building maintenance engineer, or the like) typically interacts with the building automation system via a computer that is networked with a variety of equipment controllers and sensors. In some circumstances, the user may interact with one of the equipment controllers via a mobile device (e.g., cellular phone, tablet, or the like).

### SUMMARY

Embodiments of this disclosure relate generally to a building automation system. More specifically, the embodiments relate to a system and method for locating an equipment controller within a building including a building automation system.

The embodiments described in this specification allow a user to connect a mobile device to a specific equipment controller in a system of the building (e.g., mechanical, electrical, HVAC, lighting, or the like). The user may be able to modify (e.g., configure, reconfigure, repair, or the like) a setting of an equipment controller in the building directly from the mobile device. The embodiments described in this specification allow the user to complete the modifications to the equipment controller by going directly to an area that is being controlled by the equipment controller without having to locate a blueprint or other map of the systems of the building.

In some embodiments, a mobile device can be connected to an equipment controller in a building including a building automation system. The equipment controller can be a device within various building systems. For example, the equipment controller can be a device within an HVAC system, a lighting system, a security system, or other similar system of a building.

In some embodiments, a user-initiated communication-modifying event in a building is an indication of the user's location. A user-initiated communication-modifying event can be generated based on various user actions, particularly user actions intended to cause a communication-modifying event. In some embodiments, a user-initiated communication-modifying event can include causing an increase or a decrease in a temperature reading from a sensor. For example, a user can blow on the temperature sensor to cause the increase in the temperature reading from the sensor. Alternatively, a user can blow cold air on the temperature sensor to cause a decrease in the temperature reading. In other embodiments, the user-initiated communication-modifying event can be generated by an action other than causing an increase or a decrease in a temperature reading. For example, the user can press a button on a sensor, remove batteries from a sensor, break a communication connection (physical or wireless) between an equipment controller and a sensor, or other similar user-initiated action.

A main controller for a building automation system may, in some embodiments, detect a plurality of communication-modifying events, and some of the plurality of communication-modifying events may not be user-initiated. That is, the main controller may detect both user-initiated communication-modifying events and communication-modifying events that were not initiated by the user. In such case, the main controller may not be able to distinguish between the communication-modifying events in order to determine which of the communication-modifying events were user-initiated communication-modifying events and which were communication-modifying events that were not initiated by the user. In such circumstances, the main controller can alert a user's mobile device that a plurality of equipment controllers was detected. The main controller can, for example, notify the user to initiate another user-initiated communication-modifying event. Alternatively, the main controller can, for example, notify the user to initiate a different type of user-initiated communication-modifying event. In some embodiments, when a plurality of equipment controllers is detected, the main controller may continue to monitor for a user-initiated communication-modifying event in order to isolate a single equipment controller.

In some embodiments, a mobile device can be connected in communication to a single equipment controller. In other embodiments, the mobile device can be connected in communication to a plurality of equipment controllers.

A method for determining a location of an equipment controller within a building including a building automation system is described. The method includes receiving, by a main controller of the building automation system, a request from a mobile device to locate an equipment controller. The main controller monitors one or more sensors that are in communication with the main controller for a user-initiated communication-modifying event in response to receiving the request from the mobile device. The main controller determines a hardware address of the equipment controller in response to receiving a user-initiated communication-modifying event from one of the equipment controller and of the one or more sensors.

A system for determining a location of an equipment controller within a building including a building automation system is described. The system includes a main controller configured to be in communication with a mobile device, an equipment controller and one or more sensors in communication with the main controller. The main controller is configured to monitor the one or more sensors for a user-initiated communication-modifying event in response to receiving a request from the mobile device to connect to the equipment controller. The main controller is further configured to determine a hardware address of the equipment controller in response to receiving a user-initiated communication-modifying event from one of equipment controller and of the one or more sensors.

### BRIEF DESCRIPTION OF THE DRAWINGS

References are made to the accompanying drawings that form a part of this disclosure, and which illustrate embodiments in which the systems and methods described in this specification can be practiced.

FIG. 1 illustrates a block diagram of an exemplary architecture for a building automation system, according to some embodiments.

FIG. 2 illustrates a flowchart of a method to connect a mobile device to an equipment controller, according to some embodiments.

Like reference numbers represent like parts throughout.

### DETAILED DESCRIPTION

Embodiments of this disclosure relate generally to a building automation system. More specifically, the embodiments relate to a system and method for locating an equipment controller within a building including a building automation system.

A building automation system provides centralized building control through a single, integrated system. A user (e.g., a facility manager, a building maintenance engineer, a service technician, or the like) can program and manage various building systems (e.g., climate, lighting, energy consumption, or the like) through the building automation system. The building automation system can also be connected to other building systems such as security systems (e.g., controlled entry, fire, or the like).

Generally, a building automation system includes a main controller, one or more equipment controllers, and one or more sensors. An equipment controller and a sensor can compose a subsystem of the building. A subsystem of the building can similarly be composed of an equipment controller and a plurality of sensors, or a plurality of equipment controllers and a plurality of sensors. For example, in an HVAC system of a building, a temperature sensor, thermostat, or other similar sensor, can be in communication with a variable air volume (VAV) controller (the equipment controller) in order to control airflow (and therefore climate) into a zone (e.g., a single room, a plurality of rooms, a wing of a building, or the like) of the building including the sensor (e.g., to maintain a desired temperature, humidity, or the like).

In some embodiments, a building can include more than 1,000 equipment controllers and thousands of sensors. It is to be appreciated that these numbers are exemplary and that the actual number of equipment controllers and sensors can vary beyond the stated range. Equipment controllers are often located in areas of a building that are not easily accessed (e.g., above a ceiling, or the like) for configuration, servicing, or the like. Further, the equipment controller for a particular system may not be the equipment controller physically located nearest to the area of the building it controls. As a result, a user may have to read a blueprint or other building map in order to try to locate a specific equipment controller based on the space (and/or system) the user is looking to control. Often, however, the blueprints can be difficult to read or even locate, and may not have the most current information (e.g., changes were made to a building system without updating the blueprints). Even if the appropriate equipment controller is located, the user may be unable to physically access the equipment controller for modifications.

A mobile device (e.g., a smart phone, a tablet, or the like) can be a useful tool during installation and/or troubleshooting of an equipment controller in a building. The mobile device can be connected in communication with an equipment controller. It can, however, be difficult to connect a user's mobile device with the particular equipment controller that the user wishes to service. For example, a VAV controller is typically mounted on a VAV box which is generally located above the ceiling. In such a situation, the technician may not have direct access to the VAV controller or be able to physically modify any settings on the VAV controller. Attempts have been made to leverage a global positioning system (GPS) on a mobile device. Coverage and accuracy of a GPS within a building, however, can be insufficient to adequately identify the equipment controller corresponding to the space in which the user is located.

Systems and methods for connecting a mobile device in communication with an equipment controller in a building including a building automation system are described. A user may connect to a network of the building automation system and provide a notification that the user is attempting to locate a specific equipment controller or controllers. The building automation system can monitor for a user-initiated communication-modifying event from a network of sensors in the building. If a user-initiated communication-modifying event is received by the building automation system, the building automation system provides the mobile device with a hardware address of the equipment controller(s) on the network of the building. Once the mobile device has the hardware address of the equipment controller (s), the mobile device can connect directly to the equipment controller(s) and the technician can complete a task (e.g., configuration, troubleshooting, repair, or the like, of the equipment controller).

A variable air volume (VAV) system is described by way of example in this specification. A VAV system can, for example, be a single-zone VAV system. A single-zone VAV system includes a single-zone system that delivers a variable quantity of constant-temperature air to one temperature controlled zone. A zone can be either a single space or a group of spaces that react thermally in a similar manner over time and are controlled by one thermostat. The embodiments, aspects, and concepts described in this specification can apply to equipment controllers other than in a single-zone VAV system, or VAV systems generally. For example, other equipment controllers can include a controller for a lighting system, security system, other HVAC systems, or the like.

A “mobile device” includes, for example, an electronic device that is capable of wirelessly connecting to a network. For example, a mobile device includes a smart phone, personal digital assistant (PDA), a tablet, a laptop computer, a netbook, a desktop computer and monitor on a portable cart, or other similar portable electronic device.

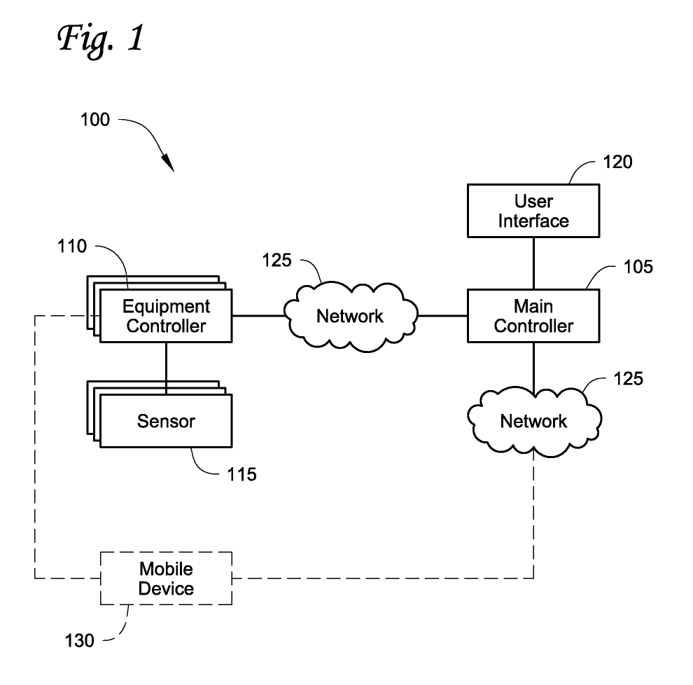

FIG. 1 illustrates a block diagram of a building automation system 100, according to some embodiments. The building automation system 100 can be configured to control one or more systems in a building (e.g., climate, lighting, energy consumption, security, or the like). The building automation system 100 includes a main controller 105, one or more equipment controllers 110, one or more sensors 115, and a user interface 120 for the main controller 105 connected in communication by a network 125. The building automation system 100 can include fewer or additional components. In some embodiments, the one or more equipment controllers 110 and the one or more sensors 115 can be directly connected instead of via the network 125.

The main controller 105 is the coordinator of the various systems and corresponding one or more equipment controllers 110 within a building (not shown). The main controller 105 is in communication with the one or more equipment controllers 110. The main controller 105 can be in direct communication with the one or more sensors 115 or in indirect communication with the one or more sensors 115 via the equipment controllers 110. In some embodiments, the main controller 105 can be physically connected to the one or more equipment controllers 110 and the one or more sensors 115. In some embodiments, the main controller 105 can be wirelessly connected to the one or more equipment controllers 105 and the one or more sensors 115. In other embodiments, a plurality of equipment controllers 110 and a plurality of sensors 110 can be included. In such embodiments, the main controller 105 can be physically connected to some of the plurality of equipment controllers 110 and some of the plurality of sensors 115 and wirelessly connected to others of the plurality of equipment controllers 110 and/or plurality of sensors 115.

The main controller 105 can, in some embodiments, receive data from the equipment controller 110. For example, the main controller 105 can receive data regarding the operating status of the one or more equipment controllers 110. In some embodiments, the main controller 105 can schedule and coordinate the various systems of the building. For example, the main controller 105 can be configured to maintain the building, or parts thereof, at a first temperature during a first time period and a second temperature during a second time period.

In addition to receiving data from the one or more equipment controllers 110, the main controller 105 can be configured to receive data directly from the one or more sensors 115. That is, the main controller 105 can monitor the various operating conditions within the building based on the one or more sensors 115. The main controller 105 can maintain a history of the received data such that the main controller 105 can identify a user-initiated communication-modifying event received from the one or more sensors 115. A user-initiated communication-modifying event can be caused by a variety of user-initiated actions. For example, a user-initiated communication-modifying event can result from a user blowing air (e.g., the user can blow or use a device such as a can of air, a lighter, a heat source, or the like) over a temperature sensor to cause a sudden increase or decrease in the temperature reading. In some embodiments, the user may be able to press a button on a sensor, touch an area of a sensor, short out a sensor, break a connection between the sensor and an equipment controller, power down a sensor, or other similar action that causes a user-initiated communication-modifying event.

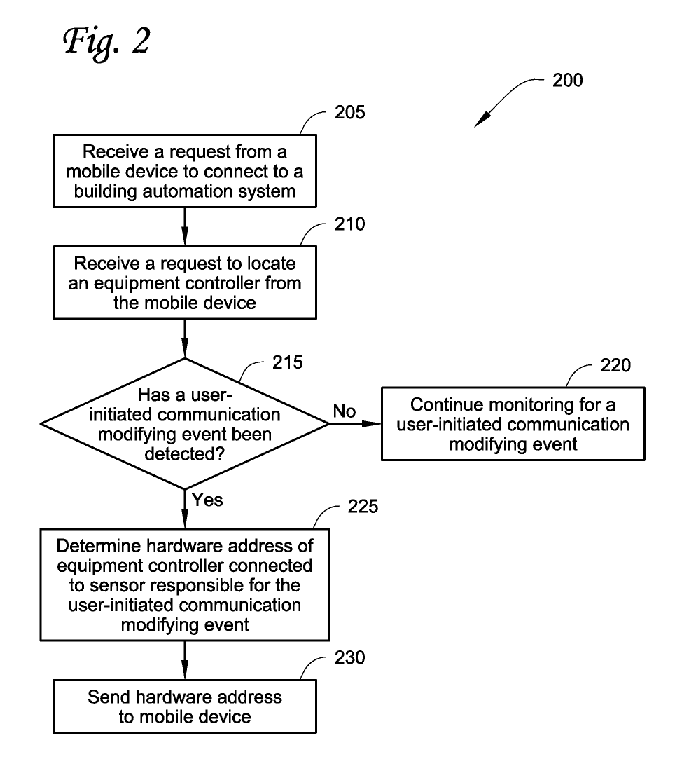

The main controller 105 can monitor the one or more equipment controllers 110 and the one or more sensors 115 for a user-initiated communication-modifying event. In some embodiments, the main controller 105 can use this monitoring to determine when a user wants to connect a mobile device to a specific equipment controller 110. Connecting a mobile device to a specific equipment controller 110 is discussed in additional detail in accordance with FIG. 2 below. The main controller 105 can perform other building management or system-level functions as well.

The main controller 105 is in communication with the one or more equipment controllers 110, the one or more sensors 115, and the user interface 120 via a network 125. The network 125 can, for example, include physical and/or wireless connections. For example, the network 125 can be a local area network (LAN) and the devices can be physically connected to each other via Ethernet cables or the like. In some embodiments, the network 125 can include a wireless network, such as through a wireless network router. In some embodiments, the network 125 can include a combination of physical and wireless connections.

In some embodiments, the main controller 105, the one or more equipment controllers 110, and the one or more sensors 115 can communicate via an Internet Protocol (IP). In some embodiments, the main controller 105, the one or more equipment controllers 110, and the one or more sensors 115 can communicate via another protocol, such as BACnet (Building Automation and Control Networking Protocol), LonTalk, or another suitable communication protocol. In other embodiments, some of the devices can communicate via IP while others can communicate via BACnet, LonTalk, or other suitable communication protocol. The communication protocol selected may be, for example, dependent upon the size of the building (e.g., the number of devices to be connected, or the like) or on the type of devices being used (e.g., some devices may only support a specific communication protocol, or the like).

Each of the one or more equipment controllers 110 may operate similarly to the main controller 105. In some embodiments, the one or more equipment controllers 110 may not receive information from each other. In other embodiments, the one or more equipment controllers 110 can receive and disseminate information from each other and operate similarly to, for example, nodes of a mesh network. In some embodiments, the one or more equipment controllers 110 may not be able to manage other equipment controllers 110. Each of the one or more equipment controllers 110 can be configured to operate independently of the main controller 105. Accordingly, each of the one or more equipment controllers 110 may be able to continue to operate according to its configuration even if there is an issue communicating with the main controller 105 (e.g., if the main controller 105 loses power, the equipment controllers 110 may still be operational). The one or more equipment controllers 110 can be located in near proximity to one or more of the sensors 115 that are providing feedback to the particular equipment controller 110. The one or more equipment controllers 110, however, may be located in areas such as ceilings that cannot be easily (or sometimes at all) accessed.

The one or more sensors 115 can be a variety of sensors. The type of sensor may depend on the system in which the sensor is operating. For example, in an HVAC system of the building there can be temperature sensors, air quality sensors (e.g., humidity, carbon dioxide, carbon monoxide, or the like), or other similar types of sensors. In a lighting system, however, the sensor can be a motion sensor, a light sensor, or other similar type of sensor. The one or more sensors 115 may have various ways in which a user can initiate a communication-modifying event. For example, a carbon monoxide sensor may be limited to user-initiated communication-modifying events such as, but not limited to, pressing a button on the sensor, removing batteries from the sensor, breaking a communication connection (physical or wireless) between an equipment controller and the sensor, or the like, in order that a technician is not adding carbon monoxide to the room.

The user interface 120 allows the user to configure, operate, monitor, re-configure, or the like, the building automation system 100. For example, the user interface 120 can include a display (not shown) that enables the user to identify a diagnostic of the systems of the building. The user interface 120 can be web-based and accessed from any browser, in some embodiments. In other embodiments, the user interface 120 can be installed on one or more electronic devices or can be both web-based and installed on one or more electronic devices. The user interface 120 can be located within the building or external to the building at an offsite location. The user interface 120 can, for example, be a computer that functions as a control center, enabling a user to view and/or manage all or part of the building automation system 100.

A mobile device 130 can be connected to the network 125 of the building automation system 100. Once connected to the network 125, the mobile device 130 can be connected in communication to a first equipment controller 110. The process of connecting the mobile device 130 to the first equipment controller 110 is discussed in further detail in accordance with FIG. 2 below.

FIG. 2 illustrates a flowchart of a method 200 to connect a mobile device (e.g., the mobile device 130 shown in FIG. 1) to an equipment controller (e.g., the one or more equipment controllers 110 shown in FIG. 1), according to some embodiments. The method 200 generally includes monitoring the equipment controllers and/or corresponding sensors (e.g., the one or more sensors 115 shown in FIG. 1) for a user-initiated communication-modifying event in response to receiving a request from the mobile device to connect to an equipment controller. Further, the method 200 generally includes determining the equipment controller(s) corresponding to the user-initiated communication-modifying event and providing a hardware address of the equipment controller(s) to the mobile device. In some embodiments, the method 200 may reduce an amount of time required for a user to connect to an equipment controller. Reducing the amount of time required to connect to the equipment controller may, in some embodiments, reduce an amount of time required for a user to perform a task (e.g., configuration, reconfiguration, servicing, or the like) on the equipment controller.

The method 200 begins at 205 when a main controller (e.g., the main controller 105 shown in FIG. 1) receives a request from a mobile device to connect to a building automation system (e.g., the building automation system 100 shown in FIG. 1). At 210, once the mobile device is connected to the building automation system, the main controller receives a request to locate an equipment controller from the mobile device. In some embodiments, 205 and 210 can be combined.

In response to receiving the request to locate an equipment controller, the main controller monitors for a user-initiated communication-modifying event at 215. As described above, a user-initiated communication-modifying event includes a variety of user actions such as causing a sudden increase or decrease in a temperature reading, powering down a sensor, or the like. The main controller can, in some embodiments, be configured to begin monitoring after an initial time delay to account for data transmission times. The main controller may monitor for a user-initiated communication-modifying event for a period of time. If no user-initiated communication-modifying event is received within the period of time, the main controller can notify the mobile device that it will need to renew its request to connect to an equipment controller. If the main controller receives signals from more than one equipment controller during this monitoring period, the main controller may notify the mobile device that multiple equipment controllers were detected. In such a case, the main controller can provide a user with options or an error message informing the user that he/she must try again. In one embodiment, the error message can inform the user that he/she should initiate a different type of user-initiated communication-modifying event.

If a user-initiated communication-modifying event is not sensed at 215, the method 200 continues to 220 and continues monitoring for a user-initiated communication-modifying event. In some embodiments, the main controller can continue monitoring until a user-initiated communication-modifying event is detected. In other embodiments, the main controller can continue monitoring until a period of time has elapsed. If the period of time elapses without receiving a user-initiated communication-modifying event, the main controller can perform an action. The action can, for example, include sending an error message to the mobile device or other similar method of notifying the user to take further action.

If a user-initiated communication-modifying event is detected at 215, the method 200 continues to 225. At 225, the main controller determines the hardware address of the equipment controller connected to the sensor where the main controller detected the user-initiated communication-modifying event. If the hardware address cannot be determined, the main controller can provide an error message to the mobile device. Following 225, the main controller provides the hardware address of the equipment controller to the mobile device at 230. In some embodiments, the mobile device can automatically connect to the equipment controller after receiving the hardware address. In other embodiments, a user may have to take a confirmation action in order to connect to the equipment controller using the hardware address provided by the main controller.

### Aspects

It is noted that any of aspects 1-9 below can be combined with any of aspects 10-14.
Aspect 1. A method for determining a location of an equipment controller within a building including a building automation system, comprising:
   receiving, by a main controller of the building automation system, a request from a mobile device to locate an equipment controller;
   monitoring, by the main controller of the building automation system, one or more sensors for a user-initiated communication-modifying event in response to receiving the request from the mobile device, wherein the one or more sensors are in communication with the main controller;
   receiving, by the main controller of the building automation system, a user-initiated communication-modifying event from one of the equipment controller and of the one or more sensors; and
   determining a hardware address of the equipment controller.
Aspect 2. The method according to aspect 1, further comprising:
   sending the hardware address of the equipment controller to the mobile device.
Aspect 3. The method according to any of aspects 1-2, further comprising:
   connecting the mobile device in communication with the equipment controller using the hardware address received from the main controller of the building automation system.
Aspect 4. The method according to any of aspects 1-3, wherein monitoring the sensor includes a time limit, wherein the monitoring continues for the time limit.
Aspect 5. The method according to aspect 4, further comprising:
   sending a notification from the main controller to the mobile device when the time limit is reached and a user-initiated communication-modifying event was not detected.
Aspect 6. The method according to any of aspects 1-5, further comprising:
   taking an action by the main controller in response to receiving a plurality of communication-modifying events.
Aspect 7. The method according to aspect 6, wherein taking an action includes:
   sending an error notification to the mobile device indicating that the user-initiated communication-modifying event was not determined.
Aspect 8. The method according to aspect 7, further comprising:
   monitoring for another user-initiated communication-modifying event from the one or more sensors.
Aspect 9. The method according to any of aspects 1-8, further comprising:
   receiving, by a main controller of the building automation system, a second request from the mobile device to locate a second equipment controller;
   monitoring, by the main controller of the building automation system, the one or more sensors for a user-initiated communication-modifying event in response to receiving the second request from the mobile device, wherein the one or more sensors are in communication with the main controller;
   receiving, by the main controller of the building automation system, a user-initiated communication-modifying event from one of the second equipment controller and of the one or more sensors; and
   determining a hardware address of the second equipment controller.
Aspect 10. A system for determining a location of an equipment controller within a building including a building automation system, comprising:
   a main controller configured to be in communication with a mobile device;
   an equipment controller in communication with the main controller;
   one or more sensors in communication with the main controller; and
   wherein the main controller is configured to:
      receive a request from the mobile device to locate an equipment controller;
      monitor the one or more sensors for a user-initiated communication-modifying event in response to receiving the request from the mobile device;
      receive a user-initiated communication-modifying event from one of the equipment controller and of the one or more sensors; and
      determine a hardware address of the equipment controller.
Aspect 11. The system according to aspect 10, wherein the sensor is in communication with the main controller.
Aspect 12. The system according to any of aspects 10-11, wherein the mobile device is configured to be connected in communication with the equipment controller.
Aspect 13. The system according to any of aspects 10-12, wherein the sensor is a temperature sensor.
Aspect 14. The system according to any of aspects 10-13, wherein the equipment controller is a variable air volume (VAV) controller.

The terminology used in this specification is intended to describe particular embodiments and is not intended to be limiting. The terms “a,” “an,” and “the” include the plural forms as well, unless clearly indicated otherwise. The terms “comprises” and/or “comprising,” when used in this specification, specify the presence of the stated features, integers, steps, operations, elements, and/or components, but do not preclude the presence or addition of one or more other features, integers, steps, operations, elements, and/or components.

The flowcharts described in this specification set forth the operations in an order which is indicative of some embodiments of the present disclosure. It is noted that in some embodiments, the order of the operations can vary. Further, one or more of the operations can be combined, or alternatively, separated into multiple operations. Other similar operations and the order of the operations may be equivalent in function, logic, or effect, without departing from the basic scope of the operations described.

With regard to the preceding description, it is to be understood that changes may be made in detail, especially in matters of the construction materials employed and the shape, size, and arrangement of parts without departing from the scope of the present disclosure. The word “embodiment” as used within this specification may, but does not necessarily, refer to the same embodiment. This specification and the embodiments described are exemplary only. Other and further embodiments may be devised without departing from the basic scope thereof, with the true scope and spirit of the disclosure being indicated by the claims that follow.

What is claimed is:

1. A method for determining a location of an equipment controller within a building including a building automation system, comprising:
receiving, by a main controller of the building automation system, a request from a mobile device to locate an equipment controller;
monitoring, by the main controller of the building automation system, one or more sensors for a user-initiated communication-modifying event in response to receiving the request from the mobile device, wherein the one or more sensors are in communication with the main controller;
receiving, by the main controller of the building automation system, a user-initiated communication-modifying event from one of the equipment controller and of the one or more sensors; and
determining a hardware address of the equipment controller.

2. The method according to claim 1, further comprising:
sending the hardware address of the equipment controller to the mobile device.

3. The method according to claim 1, further comprising:
connecting the mobile device in communication with the equipment controller using the hardware address received from the main controller of the building automation system.

4. The method according to claim 1, wherein monitoring the sensor includes a time limit, wherein the monitoring continues for the time limit.

5. The method according to claim 4, further comprising:
sending a notification from the main controller to the mobile device when the time limit is reached and a user-initiated communication-modifying event was not detected.

6. The method according to claim 1, further comprising:
taking an action by the main controller in response to receiving a plurality of communication-modifying events.

7. The method according to claim 6, wherein taking the action includes:
sending an error notification to the mobile device indicating that the user-initiated communication-modifying event was not determined.

8. The method according to claim 7, further comprising:
monitoring for another user-initiated communication-modifying event from the one or more sensors.

9. The method according to claim 1, further comprising:
receiving, by a main controller of the building automation system, a second request from the mobile device to locate a second equipment controller;
monitoring, by the main controller of the building automation system, the one or more sensors for a user-initiated communication-modifying event in response to receiving the second request from the mobile device, wherein the one or more sensors are in communication with the main controller;
receiving, by the main controller of the building automation system, a user-initiated communication-modifying event from one of the second equipment controller and of the one or more sensors; and
determining a hardware address of the second equipment controller.

10. A system for determining a location of an equipment controller within a building including a building automation system, comprising:
a main controller configured to be in communication with a mobile device;
an equipment controller in communication with the main controller; and
one or more sensors in communication with the main controller,
wherein the main controller is configured to:
receive a request from the mobile device to locate an equipment controller;
monitor the one or more sensors for a user-initiated communication-modifying event in response to receiving the request from the mobile device;
receive a user-initiated communication-modifying event from one of the equipment controller and of the one or more sensors; and
determine a hardware address of the equipment controller.

11. The system according to claim 10, wherein the sensor is in communication with the main controller.

12. The system according to claim 10, wherein the mobile device is configured to be connected in communication with the equipment controller.

13. The system according to claim 10, wherein the sensor is a temperature sensor.

14. The system according to claim 10, wherein the equipment controller is a variable air volume (VAV) controller.
